(19) United States
(12) Patent Application Publication
(10) Pub. No.: US 2016/0195907 A1
(43) Pub. Date: Jul. 7, 2016

(54) Micro Socket-Based Personal Computer

(71) Applicant: Pablo Enrique Gratas II, Valencia, CA (US)

(72) Inventor: Pablo Enrique Gratas II, Valencia, CA (US)

(21) Appl. No.: 14/588,883

(22) Filed: Jan. 2, 2015

(51) Int. Cl. G06F 1/18

(52) U.S. Cl. CPC G06F 1/184

(57) ABSTRACT

New method of designing and engineering a computer that involves a motherboard with sockets on it that has every part needed for operation with its own individual socket. The board itself is 10.2 cm×10.2 cm and has an I.O. Area and a power input area. The organization of the sockets on the motherboard area is decided upon by the inventor, and can be changed under the inventor's authorization.

The Micro Socket-Based Personal Computer is like a traditional computer, but uses sockets to manage hardware on the device. The motherboard measures 10.2 cm.×10.2 cm, but special motherboard sizes may be authorized by the inventor. Where the sockets are placed are dependent on where the inventor chooses to place them. Parts such as a central processing unit, graphics processing unit, random-access memory, storage, and other parts typically used by a traditional computer each have their own dedicated socket, the size of which can be requested to change by the manufacturer but authorized by the inventor; otherwise it is as goes; Cpu: 2 cm×2 cm, Gpu: 3 cm×3 cm, Random Access Memory: 2 cm×1 cm, Memory: 2 cm×1 cm, Memory Controller: 2 cm×2 cm, R.A.I.D. Controller 2 cm×2cm, Wireless Communications Controller: 2 cm×1 cm, I.O. Controller: 2 cm×1 cm, Chip Processes Controller: 2 cm×2 cm, Sound Processor: 2 cm×2 cm, Extra Sound Hardware: 3 cm×3 cm, I.O. area: 2 cm×3 cm×3 cm, Power Inputs: 3 cm×1 cm×3 cm. And combination of these sockets could potentially be used for a layout of the MSPC. The motherboard itself would be intended to be mounted onto the case by flaps sticking out vertically from the I.O. with holes to have the user screw in the plate to the case. Additional parts may also be added to the motherboard but must be first authorized by the inventor. The motherboard is intended to have sockets on both sides.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC

“Not Applicable”

### BACKGROUND OF THE INVENTION

This invention pertains to the field of computer science. The inventor plans to decrease the time it takes for data to be received and transmitted between hardware on the board by putting all the parts on sockets, which would generate faster transfer rates of data between components. Also, because only modules are used, manufacturing costs will go down, and profits would increase for the manufacturer.

### BRIEF SUMMARY OF THE INVENTION

The invention is a motherboard, covered in sockets on both sides, and an I.O. and a power supply area that stick out. It is recommended that metal heat plates be put on top of the components when they are in use, as the system would get very hot while in use with out them, but is not required for operation. Each individual component has its own socket, the measurements of which are listed in the summary.

### DETAILED DESCRIPTION OF THE INVENTION

This is a new design for a computer that consists of only sockets with modules placed upon them. It is intended to be manufactured using a 10. 2cm×10.2 cm motherboard, and sockets placed on that motherboard (the size of which is detailed in the specification). An I.O. plate is intended to be located at the back of the board. The only other parts on the board that is not intended to have sockets on on it is the extra sound hardware and the power input/power hardware.

1. The manufacture of a socket only motherboard type for the intended use as a computer and the use of the invention itself with the intent of monetization of any kind. The inventor does not claim any of the module designs that are intended for use with the motherboard, but the inventor claims the right to allow creation of the modules and motherboards and for the inventor to be able to manufacture the parts himself.
